(19) United States
(12) Patent Application Publication
(10) Pub. No.: US 2003/0056696 A1
(43) Pub. Date: Mar. 27, 2003

(54) Polymer-cement composites including efflorescence-control agent and method of making same

(76) Inventors: John W. Fenske, Gillett, WI (US); James N. Trotter, Vicksburg, MS (US)

Correspondence Address: JANSSON, SHUPE & MUNGER, LTD, 245 MAIN STREET, RACINE, WI, 53403, US

(21) Appl. No.: 09/955,509

(22) Filed: Sep. 18, 2001

(51) Int. Cl. C04B 24/00

(52) U.S. Cl. 106/737

(57) ABSTRACT

A polymer-cement composite composition including an efflorescence-control agent and methods of making same. The composition comprises, by weight percent, about 40 to 50% inert, inorganic filler material, such as silica sand; about 12 to 23% latex preferably in aqueous suspension; about 20 to 25% cement, preferably hydraulic cement; about 7 to 13% reactive silica; and about 0.2 to 1% of an efflorescence-control agent, which is preferably diatomatious earth. The composition is preferably manufactured by simultaneously wet mixing the powdered and liquid components at medium intensity to form a thoroughly mixed batch of green body and de-airing the green body. The green body is then formed into the desired shape followed by curing and drying. The dried product may be further processed, for example by cutting or shaping the product or coating the product.

### BACKGROUND OF THE INVENTION

1. Field of the Invention

This invention relates generally to polymer-cement composites, and more particularly, to polymer-cement composites having both cementitious and polymer bonding with a controlled surface appearance together with products made from the polymer-cement composites.

2. Description of the Related Art

Portland cement comprises, essentially, a heterogeneous mixture of calcium silicate and calcium aluminate phases that hydrate simultaneously. The calcium silicate phases make up about 75% by weight of the cement and are responsible for most of the strength development. The products of hydration are calcium-silicate-hydride (C—S—H), the cementitious binding phase, and calcium hydroxide. The C—S—H is present as a continuous, poorly crystallized, rigid gel phase, and the calcium hydroxide forms large, equiaxed crystals predominantly in large pores and capillaries. The presence of calcium hydroxide in the large pores and capillaries tends to make the cement susceptible to acid and sulfate attack. Calcium hydroxide can be leached to the surface where it carbonates to form discoloring deposits (efflorescence). The leaching increases the porosity, making the material more susceptible to infiltration and attack. Also, the presence of relatively weak calcium hydroxide crystals in the pores prevents filling of the pores with stronger C—S—H, causing a reduction in the attainable strength.

Cementitious products formed with binding phases from only cement and water typically have low strengths and are brittle, i.e., have low flexibility. A commonly used way to increase strength, by reducing porosity in cements, mortars, and concretes, is to reduce the water content, commonly reported as the water-to-cement ratio (w/c). Lowering the batch w/c ratio has a tendency to reduce the cured porosity by reducing the open pore space vacated by evaporation of excess water.

The addition of a colloidal suspension of polymer solids in water, commonly referred to as latex, to the batch improves workability and usually allows a reduction in the w/c ratio. The improvement in workability is attributed to the spherical latex particles (that act like microscopic ball bearings) and to the surfactants that are typically added to help stabilize the suspension. Thus, adequate plasticity, or flow, is attained for lower water contents. Cured product containing latex must be dried to form a continuous polymer film that, coats the open surfaces of the solid particles, cementitious matrix, pores and capillaries. This continuous coating of dried latex increases the strength, flexibility, wear resistance, impact resistance, and chemical resistance relative to cement. Latex additions to a batch also improve the adhesion or bonding to other materials.

While the presence of latex reduces cement water content, such water reduction is insufficient to avoid migration of salts to the surface of the cement during the manufacturing process. The efflorescence resulting from discoloration of these salts is a major problem confronting the manufacturer because the efflorescence imparts an irregular chalk-like appearance to the surface of the cured cement. The presence of such chalk-like appearance is unattractive and makes it difficult to achieve a uniform color in the manufactured cement product. The efflorescence is not acceptable for applications in which the cement is to be formed into high-value-added products which must have a controlled, uniform appearance. For example, the exposed surface of floor tiles, building siding and other products made of the cement must have a controlled, consistent appearance and the presence of irregular, chalk-like deposits on such exposed surfaces would detract from the appearance, and value of the finished product. Accordingly, there is an important need for a cement product which includes the beneficial properties imparted by latex yet has a controlled, uniform appearance along its surface.

In addition, prior art compositions typically have used high latex additions (a volume fraction of latex solids to cement (ls/c) between 0.4 and 0.7 or higher). This resulted in very long cement curing times and a detrimental level of water susceptibility (permeability). There is, therefore, a need in the art for an improved latex-cement or polymer-cement composition having normal or accelerated setting times, and low permeability.

In addition to the foregoing, cement and latex-cement are not very flexible. It would additionally be advantageous to be able to adjust such characteristics as strength, flexibility and durability in a polymer-cement composite.

In addition to the foregoing, the methods that can be employed to form known cement or latex-cement compositions are limited due to the high viscosity of the green (uncured) body. There is, therefore, a need in the art for an improved polymer-cement composition wherein the viscosity of the uncured batch can be adjusted to accommodate almost any forming method.

Additionally, preparation of pigmented cement presents potential contamination problems resulting from the pigments used to color the cement. Such pigmented cements are typically prepared in large scale even though only a fraction of the pigmented batch may be required to fill the customer's order. In such operations, the solid cement components are initially admixed with solid pigment in large scale (i.e., in excess of 6000 lbs./batch) with a high-intensity mixer. Next, a desired fraction of pigmented batch material is removed from the mixer and is admixed with latex and other liquid components in a smaller mixer to prepare the desired volume of the cement composition.

The large size of each batch of pigmented dry material makes it necessary to periodically remove the pigmented dry material from the mixer prior to preparation of subsequent batches having a different color pigment. The presence of pigment in the large scale dry components may create unnecessary problems in cleaning the mixer prior to changing colors resulting in loss of flexibility in responding to customer orders. Moreover, sequential admixing of the pigmented dry components followed by admixing of the pigmented dry components with the liquid components requires an additional process step thereby complicating the manufacturing process. There is, therefore, a need in the art for an improved polymer-cement composition which may be prepared in an efficient manner.

It is an object of this invention to provide a polymer-cement composite wherein unique combinations of strength, flexibility and durability, can be effected by both composition and curing procedures.

It is a further object of the invention to provide polymer-cement composites which can be made by most conventional forming methods.

It is another object of the invention to provide a polymer-cement composite such that products can be formed from the composite without the use of water-soluble polymers, thereby greatly reducing the susceptibility of the products to water-based attack or degradation.

It is still a further object of the invention to provide a polymer-cement composite for forming products wherein the flexibility of the products can be adjusted to facilitate installation methods, unlike rigid or brittle construction materials.

Yet an additional object of the invention is to provide a polymer-cement composite for forming products wherein the products can be manufactured to have certain highly-desirable properties including, without limitation, wear resistance, water and fluid impermeability and certain aesthetic characteristics.

### SUMMARY OF THE INVENTION

The foregoing and other objects, features and advantages are achieved by this invention which is a polymer-cement composite in which the physical properties of the composite are determined by the combined effects of two distinct binding phases, cementitious and polymer (latex) and the composition includes a constituent which controls efflorescence thereby producing a cement product with a controlled appearance. The composite of the present invention basically comprises an inert, inorganic filler, material (such as sand), latex, cement, reactive silica, and water. Diatomite is added to the batch to limit migration of salts to the surface of the concrete following mixing and before final drying and processing operations thereby controlling or eliminating the chalk-like appearance associated with efflorescence in the manufactured product.

In particularly preferred embodiments, the composite comprises, by weight percent, about 40 to 50% inert, inorganic filler material; about 12 to 23% latex; about 20 to 25% cement; about 7 to 13% reactive silica and about 0.2 to 1% diatomite. In preferred embodiments, the reactive silica is pozzolanic.

Additives, such as pigments and admixtures, are optional components. If present, such additives are preferably, but not exclusively, provided in an amount of up to about 3% by weight. In preferred embodiments, all solid material components have particle sizes less than 300 microns.

The term “pozzolanic” refers to materials which contain high amounts of silica (SiO₂) that are of sufficient reactivity to react at room temperature, in the presence of water, with calcia (CaO) or calcium hydroxide (Ca(OH)₂) in the cement to form C—S—H. Calcium hydroxide is produced, for example, by hydrating portland cement. Pozzolan additions in hydrating calcium aluminate cements typically react to form stratlingite (hydrated gehlenite, a calcium alununate silicate hydrate), resulting in better strength retention with time than in products not containing pozzolans.

The addition of a sufficient quantity of pozzolanic material to the batch significantly reduces porosity and permeability in the cured product, and increases long term strength. Pozzolanic reactions are slower than those of the cement components, but they react with the calcium hydroxide and deposit C—S—H into the large pores and capillaries. This can result in filling of the open capillaries and large pores, greatly reducing permeability. Filling of large pores with strong reaction product instead of relatively weak calcium hydroxide results in increased strength of the product. Reduction in the amount of calcium hydroxide that can be leached to the surface reduces the tendency to effloresce. The setting time of the composite of the present invention is normal or accelerated.

As used herein, the term “sand” means essentially inert, inorganic filler materials having particle sizes ranging from about 50 to 300 microns. These fillers include, but are not limited to, materials such as silica sand, ground nepheline syenite, ground sandstone, ground limestone, ground dolomite, coarse fly ash, and ground basalt. Lightweight, fine aggregate materials such as fly ash, perlite, and vermiculite, may be used in applications where product densities must be minimized. In preferred embodiments, the inorganic filler is silica sand. Suitable silica sand is available from U.S. Silica of Pittsburgh, Pa. under the tradename F-85 Silica.

The term “latex” means a colloidal suspension of polymer solids in water. A latex typically contains about 50 percent by weight of spherical polymer particles ranging in size from about 0.01 micron to 1 micron in diameter. The preferred latexes are those most commonly used in latex-modified concretes. These include well-known elastomeric (rubber-like), thermoplastic polymers. In specific preferred embodiments, the polymer may be, but is not limited to, polyacrylate, styrene-butadiene, or styrene-acrylate. Of course, other latex polymers, known and used by those of ordinary skill in the art, such as the alkali-swellable latexes described in U.S. Pat. Nos. 4,861,822 and 5,047,463, are within the contemplation of the present invention.

The latex polymers may be used in either dehydrated form (redispersible latex) or in suspension. “Redispersible latex” means a latex that has been dehydrated and that contains additives that enable redispersion into a water-containing mixture. Use of redispersible latex in compositions containing high amounts of latex enables lower water contents than normally attainable with latex suspensions. In preferred embodiments, however, the latex is in an aqueous suspension. In an aqueous suspension, it is preferred that the latex solids are about 56-58 wt % of the suspension and the balance largely water. In specific preferred embodiments, the latex is an aqueous polyacrylate polymer suspension or an aqueous suspension of styrene-acrylate or styrene-butadiene. In other embodiments, the latex is an aqueous co-polymer dispersion of an acrylic ester and styrene with a solids content of approximately 57%. Although viscosity of the green body is controlled by water content, water-soluble polymers in suspension can be used to further modify viscosity.

The term “cement” refers, in this invention, preferably to hydraulic cements. Hydraulic cements harden by reacting with water to form a water-resistant product that can serve to bind other materials. Most hydraulic cements usually range in particle size from about 1 to 100 microns, with median particle sizes in the 10 to 15 micron range. The most commonly used hydraulic cements are portland cement and calcium aluminate cements. For this invention, portland cement is preferred.

The term “reactive silica” refers, in specifically preferred embodiments, to pozzolanic materials, and particularly to pozzolanic materials having particle sizes fine enough to make them readily react in a hydrating, predominately calcium silicate-based (e.g., portland cement), cementitious environment. These reactive silica materials range in average particle size from about 0.01 to 45 microns. These materials include, without limitation one or more of the following: ground silica, silica fume (microsilica), precipitated silica, fly ash, and ground blast furnace slag.

The term “diatomite” refers, in this invention, preferably to diatomatious earth materials. Diatomite is a natural, mined powder which is 85% voids and interconnected pores. Diatomite is approximately 90% SiO₂. Without wishing to be bound by any particular theory, it is believed that the diatomite acts to minimize excess water in the cement composition prior to final drying and processing of the cement. The excess water is believed to be responsible for causing migration of salts, such as calcium hydroxide, to the surface of the cement where said salts carbonate to form the efflorescence. The diatomite absorbs up to 150% water by weight. A portion of the excess water is absorbed by the diatomite facilitating drying of the cement. The absorbed water remains available for reaction as needed by the cement but does not migrate to the surface thereby controlling salt migration and limiting or preventing efflorescence. Any unreacted water remaining in the diatomite is driven off later during curing. A suitable diatomite for use in the invention is Cellite C4C available from Cellite Corporation of Fernley, Nev.

The term “pigments” refers, in this invention, preferably to liquid-form pigments, although other types of solid and powdered pigments may be used in connection with certain embodiments of the invention. Glycol-based and water-based liquid pigments may be utilized.

Table 1 sets forth material components, including the average particle size of the components, for preferred embodiments of the composite aspect of the present invention:

TABLE 1

| | Material | Avg. Particle Size | Range of Addition |
|---|---|---|---|
| 1 | Sand | 130 μm | 40-50 wt % |
| 2 | Latex | 0.2 μm | 12-23 wt % |
| 3 | Cement | 10-15 μm | 20-25 wt % |
| 4 | Reactive Silica | ≦3.7 μm | 7-13 wt % |
| 5 | Water | — | 0-5 wt % |
| 6 | Diatomite | ˜40 μm | 0.2-1 wt % |

In the formulations of Table 1, sand is used as a non-reactive, coarse filler. Its rounded shape aids flow and workability to the uncured mixture.

Latex, and preferably latex solids, functions as a plasticizer in the green state. When fully cured, the latex solids form a continuous film that improves strength, flexibility, durability, weathering resistance, and chemical resistance. Cement, when fully cured, forms a continuous binding phase that imparts strength and rigidity to the product.

Reactive silica (ground and/or precipitated) is the pozzolanic material that forms a fine reactive phase that combines with calcium ions produced by the hydration of cement to form a more cementitious phase. This serves to improve strength and reduce permeability. With adequate additions of reactive silica, the molar calcia-to-silica ratio can be lowered sufficiently to somewhat minimize efflorescence. However, the inventive inclusion of diatomite is required to reduce efflorescence to the required levels needed to provide color uniformity and the desired appearance. Reactive silica additions usually improve particle packing (space filling) in the uncured batch, leading to higher densities and strengths.

Diatomite, as described above, is believed to act as an efflorescence-control agent binding with excess free water and limiting migration of salts to the surface of the cement composition prior to final drying.

In particularly preferred compositions, the ratios of the various components are constrained as set forth in Table 2.

TABLE 2

| | Components | Ratio |
|---|---|---|
| 1 | Water/cement | 0.43-0.49 by weight |
| 2 | Water/(cement + pozzolan) | 0.30-0.34 by weight |
| 3 | Latex solids/cement | 0.30-0.60 by weight |
| 4 | Sand/cement | 1.90-2.10 by weight |
| 5 | Pozzolan/cement | 0.28-0.61 by weight |
| 6 | Diatomite/cement | 0.002-0.010 by weight |
| 7 | Calcia/total reactive silica | 0.80-1.30 by moles |

In some embodiments, strength of the composite may be enhanced by the incorporation of discrete or continuous fibers, or by structural reinforcement with steel cloth, mesh, or rod, in any manner known to a person of ordinary skill in the art.

In a method aspect of the present invention, the inventive polymer-cement composite with efflorescence-control agent is generally made in the steps of mixing, curing and drying. Further process steps, for example forming the mixed polymer-cement composite or coating products formed from the polymer-cement composite following final drying, may be performed as required by the customer.

In most highly preferred mixing steps according to the invention, the liquid constituents, preferably comprising the latex and any liquid-pigment required to meet the requirements of the customer are pre-mixed in a separate vessel. The volume of pigment is selected to impart the desired color. The dry constituents, preferably comprising the sand, cement, silica and diatomite, are placed in a high intensity mixer in no particular order. Optionally, the dry constituents may be partially blended. The liquid constituents are then admixed with the dry constituents and are mixed in a single step. After mixing, the cement is preferably formed into the desired shape and then is cured and dried.

In the most highly preferred embodiments, all of the dry and liquid ingredients are mixed simultaneously under vacuum in a high intensity mixer. Advantageously, the scale of the batch may be tailored to the specific volume of cement product required to meet the needs of the customer. The complete batch is thoroughly mixed at medium intensity and de-aired.

Most preferably, the mixed polymer-cement composite is formed following mixing. The forming procedure used depends on the type of product being manufactured. For flat products such as floor or roof tiles or clapboards for use as building siding, sheets are vacuum extruded from the mixed batch, cut to size, placed into molds, pressed to shape, and de-molded. Due to the excellent rheology of the green body of the composite of the present invention, however, forming can be done by any means known to a person of ordinary skill in the art, such as extrusion, molding, pressing, vibratory casting, or centrifugal casting (to produce pipes).

Following mixing, it is most highly preferred that the formed composite is first cured and then dried. The step of curing is performed to give the polymer-cement composite time to set to a solid state and for the necessary chemical reactions to occur. The most highly preferred method of curing comprises the step of curing the formed composite at about 70-80° F. at a relative humidity of about 90-100% for a period of about 1 to 5 days. The formed cement is placed on cure boards which are then stacked one above the other. Suitable plastic sheet material is wrapped fully around the stacked cure boards to seal the formed product thereby maintaining humidity during the cure process. The exact cure time and temperature may be selected to tailor the properties of the polymer-cement composite to the needs of the customer.

Drying is next performed to drive off any remaining water in the cured product.

The cured polymer-cement composite product is removed from the cure boards and is placed on mesh racks. The racks are then placed in an oven. The most highly preferred method of drying is then performed in steps. The first step involves heating the polymer-cement composite product in the oven to a temperature of approximately 210° F. over approximately six hours. The rate of temperature increase is not critical. This removes almost all the water to avoid entrapped steam damage during final drying. The second step comprises heating the polymer-cement composite product at about 210° F. for approximately 18 hours for a total drying time cycle of roughly 24 hours.

The cured materials of the present invention have strength and elasticity properties nearly identical to those of polymer-cement composites which do not include the efflorescence-control agent. Therefore, the polymer-cement composites including the diatomite efflorescence-control agent, represent a significant advance in the art due to their excellent material properties and control of unacceptable discoloration resulting from efflorescence.

The polymer-cement composite may be further processed to impart properties tailored to the specific needs of the customer. For instance, tiles for use in flooring must be wear and slip resistant, and must be impermeable to water, fluids and contaminants. In addition, the tiles must have an attractive sheen and be easy to clean. Coatings, such as polyurethane-based coatings, may be applied to the polymer-cement composite to impart the desired finished properties to the product.

Illustrative products include, without limitation, construction products, such as indoor and outdoor floor tiles, roofing shingles and tiles, residential and commercial exterior siding, small diameter pressure pipe for residential use, and interior ceiling, wall and floor panels. Many different shapes and sizes of products can be produced due to the great flexibility in forming processes afforded by the excellent rheology of the green (uncured) body. In accordance with the principles of the invention, the construction products can be tailored to have properties from among the following: very low porosities, high flexibility, toughness, abrasion resistance, impact resistance, chemical resistance, durability, and weather resistance.

The material can be easily and safely cut with a standard tile saw. The composition can be tailored to produce products that can be nailed in place. Warping of the product does not occur if the product is cured on a flat surface and the rate of drying of the top and bottom surfaces are the same.

### BRIEF DESCRIPTION OF THE DRAWING

Comprehension of the invention is facilitated by reading the following detailed description, in conjunction with the annexed drawings, in which:

FIG. 1 is a graphical representation of the strength and flexibility (i.e., elasticity) of two polymer-cement composites with efflorescence-control agent in accordance with the invention and a polymer-cement composition not including the agent showing that the compositions have nearly identical physical properties.

### DETAILED DESCRIPTION OF THE INVENTION

Composition

In a specific illustrative embodiment of the invention, the typical ranges of addition and particle sizes for the preferred material components of this invention are set forth in Table 3.

TABLE 3

| | Material | Avg. Particle Size | | Range of Addition | |
|---|---|---|---|---|---|
| 1 | Silica Sand | 130 | μm | 41-48 | wt % |
| 2 | Latex: Suspension | — | | 13-22 | wt % |
| | (Solids) | 0.2 | μm | (7-13 | wt %) |
| 3 | Portland Cement | 10-15 | μm | 20-25 | wt % |
| 4 | Ground Silica | 3.7 | μm | 5-12 | wt % |
| 5 | Precipitated Silica | 0.015 | μm | 1-2 | wt % |
| 6 | Diatomite | ˜40 | μm | 0.2-1 | wt % |
| 7 | Pigments | 0.1-1.0 | μm | 0-1 | wt % |

| | | | | |
|---|---|---|---|---|
| 8 | Admixtures | — | 0-2 | wt % |
| 9 | Water | — | 0-5 | wt % |

Referring to Table 3, the preferred components are silica sand, latex, portland cement, ground silica, precipitated silica, pigments, admixtures, and water. Diatomite is added as a preferred efflorescence-control agent. All of these constituents are readily available through sources well-known to a person of skill in the art. We have found that using a mixture of precipitated silica and ground silica strikes a balance between reactivity, cost, and rheology. Precipitated silica is much finer than ground silica, which means that it has a very high surface area and is consequently more reactive. Unfortunately, it is also very expensive. Large additions of precipitated silica can increase the amount of water required. Ground silica is also very reactive, but has a minimal effect on the water required for formulations in the composition ranges used in the present invention.

The preferred latex is an aqueous suspension of polyacrylate polymer or copolymers, such as styrene-acrylate and styrene-butadiene. Also preferred is a latex which is an aqueous co-polymer dispersion of an acrylic ester and styrene with a solids content of approximately 57%. The colloidal nature of precipitated silica has a plasticizing effect in the batch and can be used to eliminate the need for expensive, organic, water-soluble, polymers (admixtures). Water-soluble polymers are admixtures that are universally used to facilitate most pressure-forming methods. Their use is generally considered to increase the susceptibility of a product to water-borne attack. Most admixtures are water-based and serve to help control cement hydration or uncured batch rheology.

The primary admixture used in this invention, however, is a high range water reducer (superplasticizer). The purpose of the superplasticizer, which may be commercially available salts of sulphonated napthalene formaldehyde polymers and salts of sulphonated melamine formaldehyde polymers, is to improve workability. Water, a lubricant and plasticizer, is absolutely necessary to form a stiff, workable, green body. The pigments affect no physical properties other than color, although high surface area colorants may increase the amount of water required. In these embodiments, water is supplied mostly by the latex suspension.

Processing of Material and Products

In accordance with the most highly preferred method of the present invention, the liquid constituents are first premixed. If a pigment is to be used, it is preferred that the pigment is a liquid-based pigment. The liquid-pigment is mixed with the liquid constituents. Next, the liquid constituents are admixed with the dry constituents in a single step. Such admixing is accomplished by mixing all of the dry and liquid constituents simultaneously under vacuum in a high intensity mixer. The complete batch is thoroughly mixed at medium intensity and de-aired. This single step mixing protocol permits the operator to process smaller batches of cement more specifically formulated and/or pigmented to the precise needs of the customer. The resulting green body is formed into the desired shape, and then cured and dried.

Most preferably, curing is performed by wrapping the formed polymer-cement composite product in a moisture-impermeable barrier wrap as described above to maintain humidity. The wrapped product is then cured at about 70-80° F. at a relative humidity of about 90-100% preferably for a period of about 1 to 5 days.

The product is most preferably dried in two stages as described above and according to the following protocol. First, the cured polymer-cement composite product is heated in an oven and the oven temperature gradually increased to approximately 210° F. over six hours. The first heating step removes almost all of the water to avoid entrapped steam damage during final drying. Next, the product is heated at 210° F. for about 18 hours for a total drying time cycle of about 24 hours.

The polymer-cement composite may be processed further depending on the requirements of the customer. For example, use of the polymer-cement composite as commercial floor tile requires, in some jurisdictions, that the tile have a Class 4 rating. One or more coatings may be applied to the polymer-cement composite to achieved the desired class 4 rating. A suitable coating for use in coating floor tiles (among other types of products) to achieve the desired rating is made of a polyurethane-based material available from Sumter Coating Co., Sumter S.C. under the trade name W—R polyurethane clear base/activator. Such coating may be applied with a compressed air sprayer in two separate 3 wet mil applications. As the product has 30-35% solids, each application results in a net coating of 1 mil. After each application, the coated product is first air dried with a fan for one minute and then is dried in a convection oven at 190° F. for two minutes. The fully coated product is then cured for 10 hours in a convection oven at 130° F. to complete the process. Other coatings and processes may be utilized based on the needs of the customer.

Efflorescence-Control Properties

Exemplary polymer-cement composite compositions according to the invention were prepared in order to evaluate the efficacy of the composition in limiting or preventing efflorescence on the surface of products formed from the dried composition. The efflorescence typically occurs between the time that the cement is extruded following mixing and the final drying and processing of the finished product.

A control batch and three experimental batches of the polymer-cement composite were prepared. Each batch included a base formulation including the constituents listed in Table 4.

TABLE 4
Polymer-Cement Composite Base Formulation

| | | Weight | Amount |
|---|---|---|---|
| | Material | Percent | (lbs.) |
| 1 | Portland Cement | 20.90 | 25.78 |
| 2 | Silica Sand | 41.22 | 50.83 |
| 3 | Silica Flour | 13.80 | 17.00 |
| 4 | Precipitated Silica | 1.27 | 1.57 |
| 5 | Latex | 22.00 | 27.14 |
| 6 | Pigment | .8 | 1 |
| Total | *** | 100% | 123.32 lbs. |

The four base composition batches were each prepared by admixing the constituents according to the process steps described above. Initially, the liquid latex and liquid pigment constituents were premixed. The pigment selected was a color identified as “Beaver Brown” which is a useful color for visualizing the effect of efflorescence and surface discoloration because it provides a contrasting background color to the white, chalk-like appearance of the efflorescence.

The dry constituents were placed in a high-intensity mixer. An efflorescence-control agent was added to batches 2-4 of the dry constituents. Batch 1 was provided as a control and did not include any efflorescence-control agent. Cellite C4C Diatomite was selected as the efflorescence-control agent. The diatomite was added to each batch in the amounts shown in Table 5.

TABLE 5
Efflorescence-Control Agent

| Batch | | | Amount |
|---|---|---|---|
| No. | Control Agent | Weight Percent | (lbs.) |
| 1 | None (control) | 0.0 | 0.0 |
| 2 | Cellite C4C Diatomite | 0.4 | 0.5 |
| 3 | Cellite C4C Diatomite | 0.8 | 1.0 |
| 4 | Cellite C4C Diatomite | 1.2 | 1.5 |

The pigmented liquid constituents and dry constituents were simultaneously admixed in the mixer under vacuum at medium intensity followed by de-airing. The process resulted in three 1 cubic foot batches of polymer-cement composite material. The fourth batch was not sufficiently workable to be formed because the diatomite dried the polymer-cement composite composition.

The cement material from each of batches 1-3 was extruded and formed into continuous sheets approximately 26″ wide and 3/16″ deep. The sheets were pressed into discrete sheets of about 2′×3′×3/16″.

Next, the discrete sheets were cured. The sheets were wrapped in plastic sheet material as described above to maintain a relative humidity of about 90-100% and were subsequently cured at between about 70-80° F. for a period of five days. The sheets were then dried for six hours in a convection oven, the temperature of which was gradually increased to about 210° F. over the six hour period. The sheets were dried in the oven for an additional 18 hours at about 210° F.

Two coats of Sumter polyurethane-based coating were applied to the product as described above followed by final curing of the coated sheets for 10 hours at 130° F. The coating imparted a clear luster to the sheets.

The coated sheets were then cut into 1′×1′×3/16″ tiles with a tile saw. A cut tile from each of batches 1-3 was set side by side in a well lighted area and visual observations made of the efflorescence present on the surface of the tiles. A qualitative scale was used to score the relative amount of efflorescence present on the tiles. A maximum level of efflorescence is reflected in a score of 5+. The data are as provided in Table 6.

TABLE 6
Efflorescence-Control

| | Relative | |
|---|---|---|
| | Efflorescence | |
| Batch No. | Score | Efflorescence Observed |
| 1 | + + + + | High degree of color variation attributable |
| | | to efflorescence. The product is not |
| | | acceptable. |
| 2 | + | Less efflorescence as compared to Batch 1. |
| | | Some color variation remains apparent. |
| 3 | 0 | No color variation. Very rich and consistent |
| | | color. |
| 4 | — | Not tested. Product not workable. |

The data demonstrate that the polymer-cement composite material has significantly improved efflorescence-control properties versus the control. The efflorescence-control agent of the invention is effective when provided in a weight percent range of about 0.2 (a concentration at which efflorescence-control would be expected) and about 1.

The polymer-cement composite cement had excellent flow properties and was easily mixed and processed at diatomite weight percent concentrations of between about 0.4 and 0.8. The polymer-cement composite composition was less easily mixed and processed at diatomite weight percent concentrations approaching 0.12 because the diatomite dried the polymer-cement composite composition. Therefore, a diatomite weight percent concentration of between about 0.4 and 1 weight percent is believed to be optimal in terms of controlling efflorescence and providing a polymer-cement composite composition with excellent flow properties.

Other Material Properties

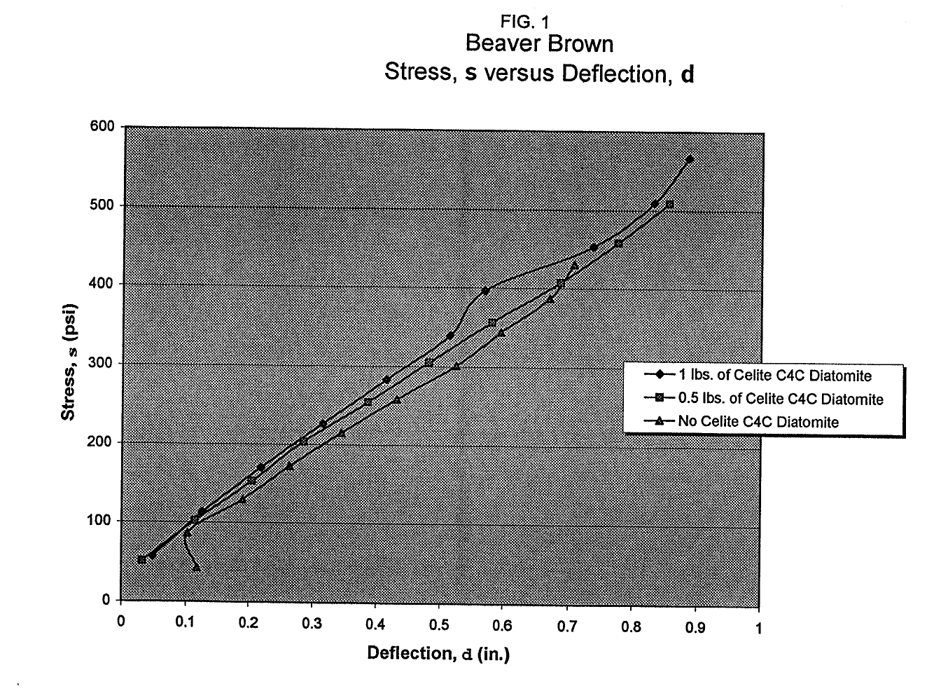

The inventive polymer-cement composites with efflorescence-control agent have nearly identical strength and flexibility (i.e., elasticity) properties as those of other polymer-cement composites (not part of the present invention) which do not include an efflorescence-control agent. FIG. 1 compares the strength and flexibility of two inventive polymer-cement composites with efflorescence-control agent versus a polymer-cement composition not including such agent. Each composition was prepared and coated as described above with respect to the compositions described in the efflorescence-control properties section above. The only difference between the compositions was that the control composition included no diatomite while the two inventive compositions respectively included 0.5 lbs. and 1.0 lbs. of diatomite as was the case in batches 2 and 3 of Table 5 above.

The test reflected in FIG. 1 consisted of a standard “beam” test. Beams were cut from sheets of each composition each beam having dimensions of 8″×1″×0.164″. Each beam was clamped to a horizontal bench surface and was cantilevered outwardly from the bench surface. A load was applied to the beams at a point 6 inches from the bench surface. Deflection of each beam was measured at the point 6 inches from the bench surface using a dial gauge indicator capable of measuring deflection to the thousandths of an inch. The load and deflection data were calculated in units of stress (psi) and deflection (in.) and the data plotted as shown on FIG. 1.

The data show that the three polymer-cement compositions have virtually identical strength and flexibility properties. In addition, and as shown in Table 7, the data show that the average modulus of elasticity of the three polymer-cement compositions is nearly identical.

TABLE 7
Average Modulus of Elasticity

| | |
|---|---|
| Control (no diatomite) | 4135.45 |
| Sample 1 (0.5 lbs. diatomite) | 4896.71 |
| Sample 2 (1.0 lbs. diatomite) | 4847.50 |

Each polymer-cement composition had excellent strength properties as indicated by the fact that the specimens did not fail despite application of a force of approximately 600 psi. Moreover, each specimen had excellent flexibility properties indicated by the fact that each material was capable of deflection of approximately 0.900″. Importantly, the presence of efflorescence-control agent in the polymer-cement composite had little, if any, affect on the strength and flexibility properties of the products formed from the compositions and did not detrimentally affect those properties. The data show that the inventive material would be excellent for use in high-value-added applications where a controlled appearance coupled with strength and durability are required. Such applications would include use of the product in applications such as indoor and outdoor floor tiles, roofing shingles and tiles, residential and commercial exterior siding, small diameter pressure pipe for residential use, and interior ceiling, wall and floor panels.

Although the invention has been described in terms of specific embodiments and applications, persons skilled in the art can, in light of this teaching, generate additional embodiments without exceeding the scope or departing from the spirit of the invention described herein. Accordingly, it is to be understood that the drawing and description in this disclosure are proffered to facilitate comprehension of the invention, and should not be construed to limit the scope thereof

What is claimed is:

1. In a polymer-cement composite comprising inert, inorganic filler material, latex, cement, reactive silica, optional additives and water, the improvement comprising: an efflorescence-control agent.

2. The polymer-cement composite of claim 1 wherein the composite comprises, by weight percent, about 40% to 50% inert, inorganic filler material; about 12 to 23% latex; about 20 to 25% cement; about 7 to 13% reactive silica; about 0.2-1% of diatomite provided as the efflorescence control agent.

3. The polymer-cement composite of claim 2 wherein all solid components have particle sizes less than 300 microns.

4. The polymer-cement composite of claim 2 wherein the inert, inorganic filler material is selected from the group consisting of silica sand, ground nepheline syenite, ground sandstone, ground limestone, ground dolomite, coarse fly ash, and ground basalt.

5. The polymer-cement composite of claim 4 wherein the inert, inorganic filler is silica sand.

6. The polymer-cement composite of claim 2 wherein the lightweight, fine aggregate material is selected from the group consisting of fly ash, perlite, and vermiculite.

7. The polymer-cement composite of claim 2 wherein the polymer solids in the latex are redispersible.

8. The polymer-cement composite of claim 2 wherein the polymer solids in the latex are in an aqueous suspension.

9. The polymer-cement composite of claim 8 wherein the latex is a colloidal suspension of polymer in water containing about 50 percent by weight of spherical polymer particles ranging in size from about 0.01 micron to 1 micron in diameter.

10. The polymer-cement composite of claim 9 wherein the colloidal suspension comprises about 56-58 percent by weight latex solids.

11. The polymer-cement composite of claim 2 wherein the polymer solids of the latex are selected from the group consisting of elastometic polymers; thermoplastic polymers; and alkali-swellable latexes.

12. The polymer-cement composite of claim 11 wherein the latex is an aqueous suspension of polyacrylate.

13. The polymer-cement composite of claim 11 wherein the latex is an aqueous suspension of styrene-butadiene polymer.

14. The polymer-cement composite of claim 11 wherein the latex is an aqueous suspension of styrene-acrylate polymer.

15. The polymer-cement composite of claim 2 wherein the cement is a hydraulic cement.

16. The polymer-cement composite of claim 15 wherein the hydraulic cement is selected from the group of portland cement and calcium aluminate cements.

17. The polymer-cement composite of claim 16 wherein the hydraulic cement is portland cement having a particle size range from about 1 to 100 microns, with median particles sizes in the 10 to 15 micron range.

18. The polymer-cement composite of claim 2 wherein the reactive silica is selected from the group consisting of ground silica, silica fume (microsilica), precipitated silica, fly ash, and ground blast furnace slag or mixtures thereof.

19. The polymer-cement composite of claim 18 wherein the reactive silica has an average particle size range from about 0.01 to 45 microns.

20. The polymer-cement composite of claim 1 wherein diatomite is the efflorescence-control agent and the components are present in the following ratios:

| | Components | Ratio |
|---|---|---|
| 1 | water/cement | 0.43-0.49 by weight |
| 2 | water/(cement + | 0.30-0.34 by weight |
| | reactive | |
| | silica) | |
| 3 | latex solids/cement | 0.30-0.60 by weight |
| 4 | filler/cement | 1.90-2.10 by weight |
| 5 | reactive | 0.28-0.61 by weight |
| | silica/cement | |
| 6 | Diatomite | 0.002-0.01 by weight |
| 7 | calcia/total reactive | 0.80-1.30 by moles |
| | silica | |

21. The polymer-cement composite of claim 2 further including optional additives are selected from the group consisting of pigments and admixtures.

22. The polymer-cement composite of claim 21 wherein the pigments are selected from the group consisting of

23. The polymer-cement composite of claim 21 wherein the admixture is an organic, water-soluble polymer useful for plasticizing.

24. The polymer-cement composite of claim 21 wherein the admixture is selected from the group consisting of salts of sulphonated napthalene formaldehyde polymers and salts of sulphonated melamine formaldehyde polymers.

25. In a polymer-cement composite comprising silica sand, latex, portland cement, a mixture of ground silica and precipitated silica, water and optionally, additives, the improvement comprising diatomite provided as an efflorescence-control agent.

26. The polymer-cement composite of claim 25 comprising:

| | Material | Avg. Particle Size | | Range of Addition | |
|---|---|---|---|---|---|
| 1 | Silica Sand | 130 | μm | 41-48 | wt % |
| 2 | Latex: Suspension | — | | 13-22 | wt |
| | (Solids) | 0.2 | μm | (7-13 | wt %) |
| 3 | Portland Cement | 10-15 | μm | 20-25 | wt % |
| 4 | Ground Silica | 3.7 | μm | 5-12 | wt % |
| 5 | Precipitated Silica | 0.015 | μm | 1-2 | wt % |
| 6 | Diatomite | ˜40 | μm | 0.2-1 | wt % |
| 7 | Pigments | 0.1-1.0 | μm | 0-1 | wt % |
| | | | | |
|---|---|---|---|---|
| 8 | Admixtures | — | 0-2 | wt % |
| 9 | Water | — | 0-5 | wt % |

27. The polymer-cement composite of claim 26 wherein the components are present in the following ratios:

| | Components | Ratio | |
|---|---|---|---|
| 1 | water/cement | 0.43-0.49 | by weight |
| 2 | water/(cement + | 0.30-0.34 | by weight |
| | reactive silica) | | |
| 3 | latex solids/cement | 0.30-0.60 | by weight |
| 4 | sand/cement | 1.90-2.10 | by weight |
| 5 | reactive silica/cement | 0.28-0.61 | by weight |
| 6 | diatomite | 0.002-0.01 | by weight |
| 7 | calcia/total reactive | 0.80-1.30 | by moles |
| | silica | | |

28. A method of making a polymer-cement composite with controlled efflorescence comprising the steps of:
simultaneously mixing:
about 40% to 50 wt % inert, inorganic filler material;
about 12 to 23 wt % latex;
about 20 to 25% cement;
about 7 to 13% reactive silica; and
about 0.2-1% efflorescence control agent;
to form a green body
forming the green body into the desired shape of a product;
curing the product; and
drying the product.

29. The method of claim 28 wherein the efflorescence-control agent comprises diatomite.

30. The method of claim 28 further including the step of de-airing the green body following the mixing step.

31. The method of claim 28 wherein the forming step is selected from the group of any of the following methods: extruding, molding, pressing, vibratory casting, and centrifugal casting.

32. The method of claim 31 wherein the step of forming the mixed batch into the desired shape comprises:
vacuum extruding flat sheets from the mixed batch;
cutting the extruded sheets to the desired size;
placing the sheets into molds;
pressing the sheets in the molds to shape; and
de-molding the product.

33. The method of claim 28 wherein the step of curing the product comprises:
enclosing the product with a barrier material; and
curing the product at about 70-80° F. at a relative humidity of about 90-100% for a period of about 1 to 5 days.

34. The method of claim 28 wherein the step of drying the product comprises:
heating the product to a temperature of approximately 210° F. over six hours; and
heating the product at approximately 210° F. for about an additional 18 hours for a total drying time cycle of about 24 hours.

35. The method of claim 28 including the further step of coating the dried product.

36. The method of claim 35 wherein the coating step comprises the steps of:
applying at least one polyurethane-based coating to the dried product; and
drying the coating.
